(19) United States
(12) Patent Application Publication
(10) Pub. No.: US 2007/0246457 A1
(43) Pub. Date: Oct. 25, 2007

(54) Fixing device for image forming apparatus and fixing method

(75) Inventors: Yoshinori Tsueda, Fuji (JP); Satoshi Kinouchi, Shinjuku (JP); Osamu Takagi, Chofu (JP); Toshihiro Sone, Yokohama (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/407,800

(22) Filed: Apr. 20, 2006

(51) Int. Cl. H05B 6/14

(52) U.S. Cl. 219/619

(57) ABSTRACT

A fixing device for an image forming apparatus according to the present invention is configured in such a manner that both end portions of a form rubber layer are formed so as to be thicker than a center portion thereof for absorbing expansion of the foam rubber layer by a space between the foam rubber layer and a metal conductive layer. Accordingly, the hardness of a heat roller at the time of fixation becomes substantially uniform over the entire length thereof in the longitudinal direction. A pressure roller is out of contact with the heat roller until warming up is completed, and the pressure roller is brought into pressure contact with the heat roller after the heat roller has reached a warming up complete temperature, so that a load applied to both end portions of the heat roller is alleviated.

### BACKGROUND OF THE INVENTION

1. Field of the Invention

The present invention relates to a fixing device for an image forming apparatus mounted to the image forming apparatus such as a copying machine, a printer, a facsimile for thermally fixing a toner image.

2. Description of the Background

As a fixing device to be used for an image forming apparatus such as copying machines, printers, and so on of an electrophotographic type, there is a fixing device that inserts a sheet paper through a nip formed between a heat roller and a pressure roller and fixes a toner image by heat and pressure. Recent years, as a heating type fixing device, there is a device that covers a surface of a resilient member layer formed on the outside of a core member of the heat roller with a metal conductive layer and heats the metal conductive layer with an induction heating system. The induction heating system is a system to supply a predetermined electric power to an induction heating coil to generate a magnetic field and heat the metal conductive layer in a moment of time by an eddy current generated in the metal conductive layer by the magnetic field to heat the heat roller.

In this manner, the heat roller that covers the surface of the resilient member layer with the metal conductive layer is configured in such a manner that the coefficient of thermal expansion of the resilient member layer such as sponge containing fine air bubbles is higher than the coefficient of thermal expansion of the metal conductive layer. Therefore, when heating the heat roller, the hardness of the heat roller in the longitudinal direction becomes non-uniform due to the difference in coefficient of thermal expansion between the resilient member layer and the metal conductive layer. The non-uniformity in hardness of the heat roller in the longitudinal direction causes a change in nip width or a change in the shape of the heat roller, which affects the fixing ability.

In order to avoid it, in the related art, the resilient member layer is formed into a dumbbell shape having an outer diameter at a center portion thereof being smaller than that at both end portions in the longitudinal direction. Accordingly, the center portion of the heat roller in the longitudinal direction is provided with a space between the resilient member layer and the metal conductive layer. With this space, the resilient member layer is thermally expanded when the heat roller is heated, and prevents the metal conductive layer from being pushed upward from inside, so that the hardness of the heat roller in the longitudinal direction is maintained uniformly.

However, when the resilient member layer is formed into the dumbbell shape, a load generated by being in contact with the pressure roller concentrates to the both end portions of the heat roller until the heat roller reaches a fixable temperature. Therefore, the heat roller may become damaged in an early stage such that boundary portions of the resilient member layer being in contact with a core member become damaged at both end portions of the heat roller.

Therefore, in the fixing device for performing heat fixation by the heat roller in which the surface of the resilient member body is covered with the metal conductive layer, development of a fixing device for an image forming apparatus in which the hardness of the heat roller in the longitudinal direction is maintained uniformly to obtain preferable fixing ability and prevent damage in the early stage irrespective of the load generated by being in contact with the pressure roller so that the long lifetime is achieved has been expected.

### SUMMARY OF THE INVENTION

Accordingly, an advantage of the present invention is to provide a fixing device for an image forming apparatus for performing heat fixation with a heat roller in which a surface of a resilient member layer is covered with a heat conductive layer, wherein even though a space for releasing expansion of the resilient member layer is provided, a pressing force of a pressure roller with respect to the heat roller is varied to prevent a load from concentrating to both end portions of the heat roller so that a long lifetime of the heat roller is achieved.

To achieve the above advantage, one aspect of the present invention is to provide a fixing device for an image forming apparatus having a heating rotary member formed by covering a surface of a resilient member layer with a metal conductive layer, an induction heating mechanism for generating an induction current in the metal conductive layer, a pressure member which can come into contact with the heating rotary member for nipping and carrying a recording medium with the heating rotary member, a pressure mechanism which can vary a pressing force of the pressure member with respect to the heating rotary member in a plurality of steps or release the pressing force of the pressure member with respect to the heating rotary member.

### BRIEF DESCRIPTION OF THE DRAWINGS

FIG. 1 is a schematic block diagram showing an image forming apparatus according to a first embodiment of the present invention;

FIG. 2 is a schematic layout drawing of a fixing device according to the first embodiment of the present invention viewed from a direction orthogonal to an axis of a heat roller;

FIG. 3 is a schematic perspective view showing the heat roller according to the first embodiment of the present invention;

FIG. 4 is a schematic block diagram showing a control system of the fixing device according to the first embodiment of the present invention;

FIG. 5 is a schematic explanatory drawing showing the fixing device according to a second embodiment of the present invention;

FIG. 6 is a schematic explanatory drawing showing the fixing device according to a third embodiment of the present invention;

FIG. 7 is a schematic layout drawing of the fixing device of the third embodiment of the present invention when viewed from the direction orthogonal to the axis of the heat roller;

FIG. 8 is a schematic block diagram of a control system of the fixing device according to a fourth embodiment of the present invention;

FIG. 9 is a schematic layout drawing of the fixing device according to a fifth embodiment of the present invention viewed from the direction orthogonal to the axis of the heat roller; and

FIG. 10 is a schematic explanatory drawing viewed from a direction showing the fixing device according to the fifth embodiment of the present invention.

### DETAILED DESCRIPTION OF THE INVENTION

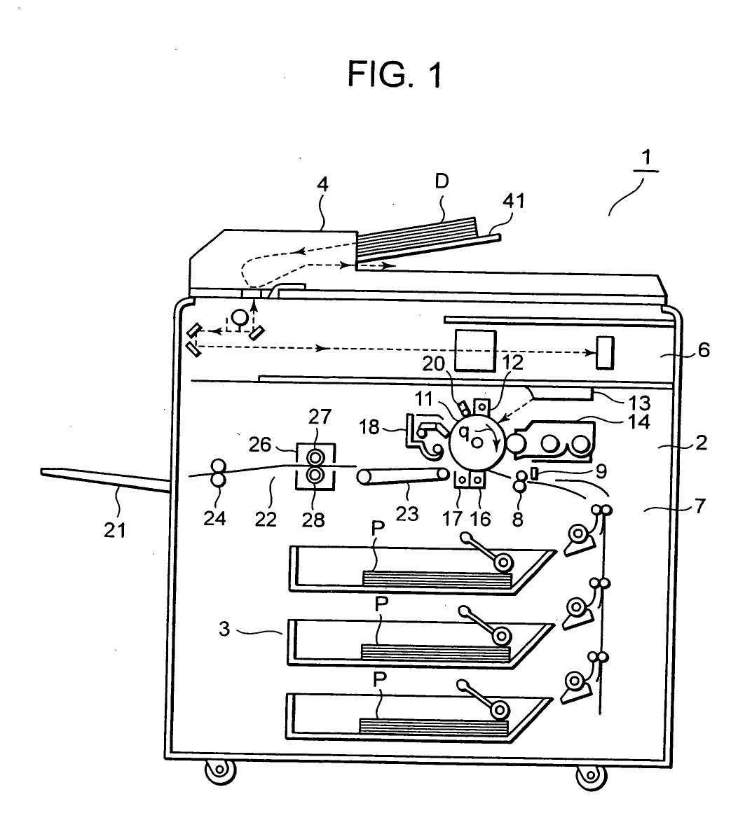

Referring now to the attached drawings, a first embodiment of the present invention will be described in detail. FIG. 1 is a schematic block diagram showing an image forming apparatus 1 including a fixing device 26 according to one embodiment of the present invention mounted thereon. The image forming apparatus 1 includes a cassette mechanism 3 for supplying a paper P as a fixed medium to an image forming unit 2, and a scanner unit 6 for reading an original document D supplied by an automatic document feeding device 4 on an upper surface thereof. A registration roller 8 is provided on a carrier path 7 from the cassette mechanism 3 to the image forming unit 2.

The image forming unit 2 includes a charging device 12 for charging a photoconductive drum 11 uniformly according to the direction of rotation of the photoconductive drum 11 in sequence as indicated by an arrow q, a laser exposure device 13 for forming a latent image on the basis of image data from the scanner unit 6 on the charged photoconductive drum 11, a developing device 14, a transfer charger 16, a separation charger 17, a cleaner 18, a neutralization LED 20 in the periphery of the photoconductive drum 11. The image forming unit 2 forms a toner image on the photoconductive drum 11 in an image forming process according to a known electrophotographic system and transfer the same to the paper P.

On the downstream of the image forming unit 2 in the paper P carrying direction, a paper eject carrier path 22 for carrying the paper P on which the toner image is transferred toward a paper eject unit 21 is provided. A carrier belt 23 for carrying the paper P separated from the photoconductive drum 11 to the fixing device 26 and a paper eject roller 24 for ejecting the paper P after having passed through the fixing device 26 to the paper eject unit 21 are provided on the paper eject carrier path 22.

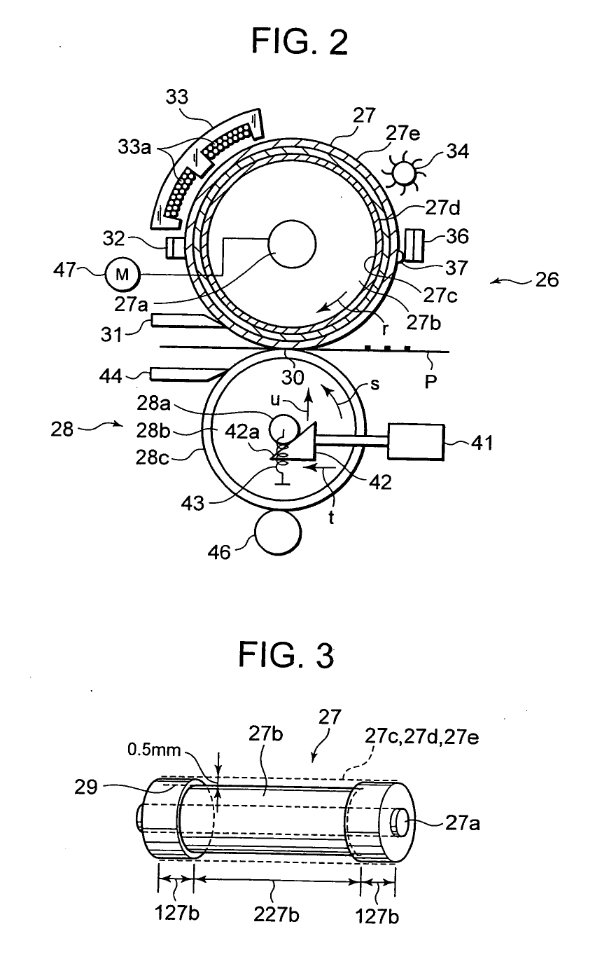

Subsequently, the fixing device 26 will be described. FIG. 2 is a schematic block diagram showing the fixing device 26. The fixing device 26 includes a heat roller 27 as a heating rotary member, and a pressure roller 28 as a pressure member. The fixing device 26 includes a motor 47 as a drive mechanism for supplying a rotational force to a shaft member 27a of the heat roller 27. The pressure roller 28 comes into and out of contact with the heat roller 27 by a push-up cam 42 which is slid by a solenoid 41. The solenoid 41 and the push-up cam 42 constitute a pressure mechanism. The cam portion 42a of the push-up cam 42 comes into abutment with a shaft member 28a of the pressure roller 28 and pushes the pressure roller 28 upward. On the other hand, a tensile force in the direction coming apart from the heat roller 27 against a push-up force of the push-up cam 42 is supplied to the shaft member 28a of the pressure roller 28 by a pressure releasing spring 43.

A separating claw 31 for preventing winding of the paper P after fixation, a thermistor 32 for detecting the surface temperature of an end portion of the heat roller 27, an induction heating device 33 as a induction heating mechanism, a cleaning device 34, an infrared ray temperature sensor 36 for detecting the surface temperature of the heat roller 27 without contact, and a thermostat 37 for detecting abnormality of the surface temperature of the heat roller 27 and shutting down heating are provided in the periphery of the heat roller 27 along the direction of rotation of the heat roller indicated by an arrow r. The heat roller 27 includes, for example, a foam rubber layer 27b as a resilient member layer, a metal conduction layer 27c, a silicon rubber layer 27d, and a releasing layer 27e in the periphery of the shaft member 27a of 20 mm in diameter, and is 40 mm in diameter.

In the periphery of the pressure roller 28, a separation claw 44 for preventing winding of the paper P, and a cleaning roller 46 are provided along the direction of rotation of the pressure roller as indicated by an arrow s. The pressure roller 28 includes, for example, a silicone rubber layer 28b having resiliency and a releasing layer 28c formed of fluorocarbon rubber in the periphery of the shaft member 28a and is 40 mm in diameter.

When the pressure roller 28 is pressed against and brought into contact with the heat roller 27 against a spring force of the pressure releasing spring 43 by being pushed up by the push-up cam 42, the surface of the heat roller 27 is resiliently deformed. Accordingly, a nip 30 having a constant contact width with respect to the sheet paper carrying direction is formed between the heat roller 27 and the pressure roller 28.

The foam rubber layer 27b of the heat roller 27 is formed of foam rubber which is foamed silicon rubber or the like, and is bonded to the shaft member 27a. As shown in FIG. 3, the thickness of the foam rubber layer 27b is 7.5 mm at both end portions 127b in the longitudinal direction and is 7 mm at a center portion 227b. Accordingly, a space of about 0.5 mm is formed between the foam rubber layer 27b and the metal conductive layer 27c at the center portion 227b of the heat roller 27 in the longitudinal direction. A vent hole 29 for releasing air in the space when the foam rubber layer 27b is thermally expanded is formed at one end portion 127b of the foam rubber layer 27b.

The metal conductive layer 27c of the heat roller 27 is formed of, for example, aluminum (Al) of 0.02 to 0.1 mm in thickness and covers the foam rubber layer 27b. The material of the metal conductive layer 27c is not limited as long as it is a material which generates heat by an eddy current such as nickel (Ni) or Iron (Fe). The silicon rubber layer 27d is formed to have a thickness of approximately 200 μm. The releasing layer 27e is composed of fluorocarbon resin (PFA or PTFE (Polytetrafluoroethylene), or mixture of PFA and PTFE) having a thickness of approximately 30 μm. The both end portions 127b of the foam rubber layer 27b and the metal conductive layer 27c are bonded by silicon system heat resistant adhesive agent.

A conductive heating device 33 includes an induction heating coil 33a. When a drive current is supplied to the induction heating coil 33a, a magnetic field is generated. The induction heating device 33 generates an eddy current in the metal conductive layer 27c by the magnetic field to heat the metal conductive layer 27c.

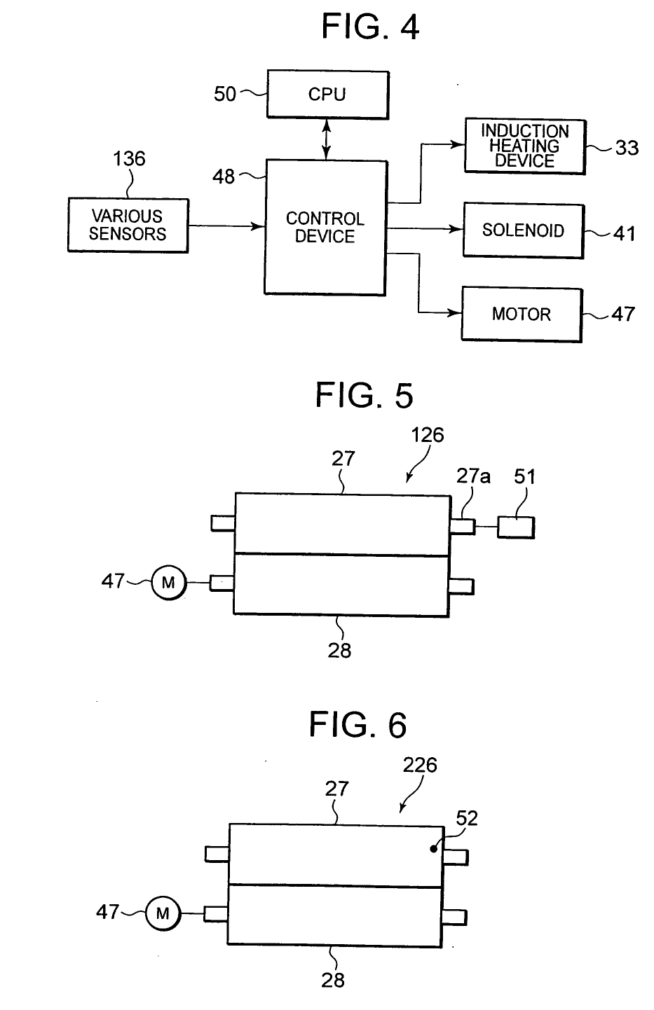

The control system of the fixing device 26 is configured in such a manner that a control device 48 is connected to a CPU 50 for controlling a main body of the image forming apparatus 1, as shown in FIG. 4. Detected results from various sensors 136 including the thermistor 32, the infrared ray temperature sensor 36 and the thermostat 37 are supplied to an input side of the control device 48. The induction heating device 33, the solenoid 41, the motor 47 and so on are connected to an output side of the control device. The drive current of the induction heating device 33 is controlled according to the detected result of the infrared ray temperature sensor 36. The solenoid 41 is controlled between ON and OFF according to the detected result of the infrared ray temperature sensor 36. The motor 47 is controlled in its driving state according to a control signal from the CPU 50.

Subsequently, an operation will be described. When a power source of the image forming apparatus 1 is turned ON, warming up of the fixing device 26 is started first. Accordingly, the motor 47 is driven and the heat roller 27 is rotated in the direction indicated by the arrow r. The drive current is supplied to the induction heating coil 33a to heat the metal conductive layer 27c. At the time when this warming up is started, the solenoid 41 is turned OFF and no push-up force is applied from the push-up cam 42 to the pressure roller 28.

Therefore, the pressure roller 28 is out of contact with the heat roller 27 by the spring force of the pressure releasing spring 43. Since the temperature of the heat roller 27 when the warming up is started is substantially the same as a room temperature, the foam rubber layer 27b is not thermally expanded. Therefore, a space of about 0.5 mm is formed between the foam rubber layer 27b at the center portion 227b and the metal conductive layer 27c of the heat roller 27.

When heating of the metal conductive layer 27c by the induction heating device 33 is proceeded, the foam rubber layer 27b and the metal conductive layer 27c are thermally expanded. However, since the coefficient of thermal expansion of the foam rubber layer 27b is higher than the metal conductive layer 27c, the space at the center portion 227b of the heat roller 27 is filled with the foam rubber layer 27b, and hence the foam rubber layer 27b and the metal conductive layer 27c are brought into tight contact with each other at the center portion 227b of the heat roller 27. Air in the space at the center portion 227b of the heat roller 27 is discharged from the air vent 29. The hardness of the heat roller 27 at this time is substantially uniform over the entire length in the longitudinal direction.

When the temperature of the heat roller 27 reaches 17° C. as a warming up completion temperature, the control device 48 stops heating by the metal conductive layer 27c according to the detected result of the infrared ray temperature sensor 36. Furthermore, the control device 48 stops the motor 47 temporarily to stop the rotation of the heat roller 27. Subsequently, the control device 48 turns the solenoid 41 ON to slide the push-up cam 42 in the direction indicated by an arrow t. It takes about 30 seconds from the start of warming up and the completion of warming up at which the temperature of the surface of the heat roller 27 reaches 170° C. However, the temperature of the foam rubber layer 27b within the heat roller 27 does not rise abruptly. Therefore, after having waited for a period after the temperature of the surface of the heat roller 27 has reached 170° C. until a predetermined expansion of the foam rubber layer 27b is achieved, for example, for about 60 seconds, the solenoid 41 is turned ON.

Accordingly, a cam portion 42a of the push-up cam 42 pushes up the shaft member 28a of the pressure roller 28 in the direction indicated by an arrow u, and the pressure roller 28 is brought into pressure contact with the heat roller 27 at a pressing force of 40 kg. Accordingly, the nip 30 which can sufficiently fix the toner image is formed between the heat roller 27 and the pressure roller 28. When the warming up is completed, the foam rubber layer 27b is thermally expanded sufficiently, and hence there is no difference in outer diameter between the both end portions 127b and the center portion 227b. In other words, by the sufficient thermal expansion of the foam rubber layer 27b, the foam rubber layer 27b and the metal conductive layer 27c are in tight contact with each other over the entire length of the heat roller 27 in the longitudinal direction. Therefore, the pressing force of the pressure roller 28 is loaded substantially uniformly over the entire length of the heat roller 27 in the longitudinal direction. In other words, the pressing force generated at the nip 30 becomes uniform over the entire length of the heat roller 27 in the longitudinal direction. The load applied to a boundary between the shaft member 27a and the foam rubber layer 27b also becomes uniform.

At this time, on the side of the main body of the image forming apparatus 1, the CPU 48 displays that the warming up is completed and hence it is a ready state on a control panel (not shown) or the like according to the detected result from the infrared ray temperature sensor 36. After the heat roller 27 reaches the warming up completion temperature, according to the detected result of the infrared ray temperature sensor 36 and the thermistor 32, the ready temperature of 160±10° C. is maintained. In other words, in the ready state, the control device 48 controls the induction heating device 33 and the motor 47 between ON and OFF in a state in which the pressure roller 28 is in pressure contact with the heat roller 27 by the pressing force of 40 kg, so that the heat roller 27 is maintained at the temperature of 160±10° C.

When a printing operation is instructed in this ready state, the image forming apparatus 1 starts an image forming process. In the image forming unit 2, the photoconductive drum 11 rotating in the direction indicated by the arrow q is charged uniformly by the charging device 12, and a laser beam is irradiated thereon by the laser exposure device 13 according to information of the original document, so that a electrostatic latent image is formed thereon. Subsequently, the electrostatic latent image is developed by the developing device 14 and the toner image is formed on the photoconductive drum 11.

The toner image on the photoconductive drum 11 is transferred to the paper P by the transfer charger 16. Subsequently, the paper P is separated from the photoconductive drum 11 and carried to the fixing device 26. In the fixing device 26, the paper p is inserted into the nip 30 between the heat roller 27 driven and rotated by the motor 47 and the pressure roller 28 rotated following thereto, and the toner image is fixed by heat and pressure.

Since the pressing force generated at the nip 30 at this time is uniform over the entire length of the heat roller 27, a sufficient nip width over the entire length of the heat roller 27 is secured, and the toner image on the paper P is desirably fixed over the entire length in the scanning direction. The load applied to the boundary of the foam rubber layer 27b that comes into contact with the shaft member 27a of the heat roller 27 does not concentrate to the both end portions 127b, and is substantially uniform over the entire length of the foam rubber layer 27b.

When the power source is turned OFF after having repeated the image forming process as described above in sequence, the solenoid 41 is turned OFF and the pressure roller 28 comes out of contact with the heat roller 27 by the spring force of the pressure releasing spring 43.

According to this embodiment, in order to absorb difference in coefficient of thermal expansion between the foam rubber layer 27b and the metal conductive layer 27c, the both end portions 127b of the foam rubber layer 27b are formed to a thickness larger than the center portion 227b. Therefore, at the time of fixation, the hardness of the heat roller 27 is substantially uniform over the entire length in the longitudinal direction. In other words, the nip 30 between the heat roller 27 and the pressure roller 28 can be provided with a uniform pressing force over the entire length of the heat roller 27 in the longitudinal direction. Consequently, a desirable fixed image can be obtained over the entire length in the scanning direction.

Furthermore, according to this embodiment, while the pressure roller 28 is out of contact with the heat roller 27 until the warming up of the heat roller 27 is completed, the pressure roller 28 is brought into pressure contact with the heat roller 27 after the heat roller 27 reaches the warming up completion temperature and the foam rubber layer 27b is thermally expanded sufficiently. In other words, the pressure roller 28 is brought into pressure contact with the heat roller 27 after the difference in outer diameter between the both end portions 127b and the center portion 227b of the foam rubber layer 27 is eliminated, and the foam rubber layer 27b and the metal conductive layer 27c come into tight contact with each other over the entire length of the heat roller 27 in the longitudinal direction. Therefore, at the time of pressure contact of the pressure roller 27, the load applied to the boundary between the shaft member 27a and the foam rubber layer 27b of the heat roller 27 becomes uniform over the entire length of the heat roller 27 in the longitudinal direction. Consequently, damage of the both end portions 127b of the foam rubber layer 27b caused by concentration of the load to the both end portions 127b of the foam rubber layer 27b can be prevented, and hence the long lifetime of the heat roller 27 is achieved.

Subsequently, a second embodiment of the present invention will be described. In addition to the first embodiment described above, the second embodiment is configured in such a manner that the pressure control of the pressure roller 28 is carried out by detecting a drive/driven relation between the heat roller 27 and the pressure roller 28, and other structures are the same as the first embodiment. Therefore, in the second embodiment, the same parts as those described in the first embodiment are represented by the same reference numerals and detailed description thereof are omitted.

A fixing device 126 in the second embodiment includes the motor 47 on the side of the shaft member 28a of the pressure roller 28 as shown in FIG. 5, and the heat roller 27 is driven by the pressure roller 28. When the solenoid 41 is in OFF, the cam portion 42a of the push-up cam 42 pushes the shaft member 28a of the pressure roller 28 in the direction indicated by the arrow u so that the pressing force of the pressure roller 28 with respect to the heat roller 27 becomes 5 kg. When the solenoid 41 is ON, the cam portion 42a of the push-up cam 42 pushes up the shaft member 28a of the pressure roller 28 in the direction indicated by the arrow u so that the pressing force of the pressure roller 28 with respect to the heat roller 27 becomes 40 kg.

An encoder 51 for detecting the number of rotations of the shaft member 27a is connected to one end of the shaft member 27a of the heat roller 27. The number of rotations of the shaft member 27a detected by the encoder 51 is supplied to the control device 48.

Subsequently, the operation will be described. When the warming up is started by turning the power source of the image forming apparatus 1 ON, the solenoid 41 is in an OFF state, and a push-up force of the push-up cam 42 is applied to the pressure roller 28 so that the pressing force of the pressure roller 28 with respect to the heat roller 27 becomes 5 kg. When the warming up starts, the control device 48 drives the motor 47, and supplies the drive current to the induction heating coil 33a. The number of rotations of the shaft member 27a of the heat roller 27, which is detected by the encoder 51, is supplied to the control device 48. Accordingly, the heat roller 27 which comes in pressure contact with the pressure roller 28 follows the rotation of the pressure roller 28 in the direction indicated by the arrow s and hence is rotated in the direction indicated by the arrow r.

However, the temperature of the heat roller 27 when the warming up is started is substantially the same as a room temperature, a space of about 0.5 mm is formed between the foam rubber layer 27b and the metal conductive layer 27c at the center portion 227b of the heat roller 27 and the heat roller 27 and the pressure roller 28 are in pressure contact with each other only at the both end portions 127b of the heat roller 27. Therefore, the driving rotation of the pressure roller 28 is transmitted only to the heat roller at the both end portions 127b of the heat roller 27, whereby the heat roller 27 cannot be provided with a sufficient rotational force. Therefore, the number of driven rotations of the heat roller 27 detected by the encoder 51 is not stable.

Then, as heating of the metal conductive layer 27c by the induction heating device 33 is proceeded, the space at the center portion 227b of the heat roller 27 is filled with the foam rubber layer 27b by the thermal expansion, and hence the foam rubber layer 27b and the metal conductive layer 27c at the center portion 227b of the heat roller 27 are brought into tight contact with each other. At this time, the driving rotation of the pressure roller 28 is transmitted to the entire length of the heart roller 27 in the longitudinal direction. Therefore, the heat roller 27 can obtain a sufficient rotational force from the pressure roller 28 and the number of driven rotations of the heat roller 27 becomes stable and constant.

When the number of driven rotations of the heat roller 27 becomes constant (for example, assuming that a process velocity of the image forming apparatus 1 is 200 m.p.s., the number of driven rotations corresponding to this velocity) from the detected result of the encoder 51, the control device 48 turns the solenoid 41 ON and slides the push-up cam 42 in the direction indicated by the arrow t. Accordingly, the cam portion 42a of the push-up cam 42 further pushes up the shaft member 28a of the pressure roller 28 in the direction indicated by the arrow u, so that the pressing force of the pressure roller 28 with respect to the heat roller 27 becomes 40 kg. In contrast, on the side of the main body of the image forming apparatus 1, when the number of driven rotations of the heat roller 27 becomes constant from the detected results of the encoder 51, the warming up of the heat roller 27 is completed and displays the fact that it is a ready state considering that the foam rubber layer 27b has achieved a predetermined expansion. Subsequently, the image forming apparatus 1 maintains the ready state according to the detected results of the infrared ray temperature sensor 36 and the thermistor 32.

Subsequently, the image forming process is carried out in the same manner as the first embodiment. When the power source is turned OFF after having terminated the entire image forming process, the solenoid 41 is turned OFF and the push-up cam 42 is slid in a direction opposite from the direction indicated by the arrow t. Accordingly, the pressure roller 28 is pulled in a direction opposite from the direction indicated by the arrow u by a spring force of the pressure releasing spring 43, so that the pressing force of the pressure roller 28 with respect to the heat roller 27 is reduced back to 5 kg.

In this embodiment, although it is described that timing for varying the pressing force of the pressure roller 28 is when the number of driven rotations of the heat roller 27 becomes constant from the detected result of the encoder 51, it is not limited thereto. For example, it is also possible to leave the solenoid 41 in the OFF state even after the number of driven rotations of the heat roller 27 becomes constant, and then turn the solenoid 41 ON only during a period in which the image forming process is carried out by a printing instruction or the like to change the pressing force of the pressure roller 28 with respect to the heat roller 27 to 40 kg. In other words, it is also possible to maintain the pressing force of the pressure roller 28 with respect to the heat roller 27 at a low level while it is in the ready state even after the warming up is completed, and increase the pressing force of the pressure roller 28 only when the image forming process is carried out.

According to this embodiment, as in the first embodiment, the nip 30 is provided with the pressing force uniformly over the entire length of the heat roller 27 in the longitudinal direction at the time of fixation.

Consequently, a fixed image which is uniform and desirable is obtained over the entire length of the scanning direction.

Furthermore, in this embodiment, the pressing force of the pressure roller 28 with respect to the heat roller 27 is set to a low value, 5 kg until the number of driven rotations of the shaft member 27a of the heat roller 27 becomes stable. On the other hand, when the foam rubber layer 27b is thermally expanded sufficiently and the number of driven rotations of the shaft member 27a of the heat roller 27 becomes stable, or only when the image forming process is carried out after the number of driven rotations of the shaft member 27a of the heat roller 27 becomes stable, the pressing force of the pressure roller 28 with respect to the heat roller 27 is increased to 40 kg. Therefore, even when the heat roller 27 and the pressure roller 28 are brought into pressure contact with each other only at the both end portions 127b of the heat roller 27 at a low temperature, the load applied to the both end portions 127b of the heat roller 27 is low. Consequently, damage of the both end portions 127b of the foam rubber layer 27b which is caused by concentration of the load to the both end portions 127b of the foam rubber layer 27b can be prevented, and hence the long lifetime of the heat roller 27 is achieved.

Subsequently, a third embodiment of the present invention will be described. In addition to the second embodiment described above, the third embodiment is configured in such a manner that the drive/driven relation between the heat roller 27 and the pressure roller 28 is detected by using the peripheral velocity of the heat roller 27, and other configurations are the same as those in the second embodiment. Therefore, in the third embodiment, the parts as those described in the second embodiment are represented by the same reference numerals and detailed description thereof are omitted.

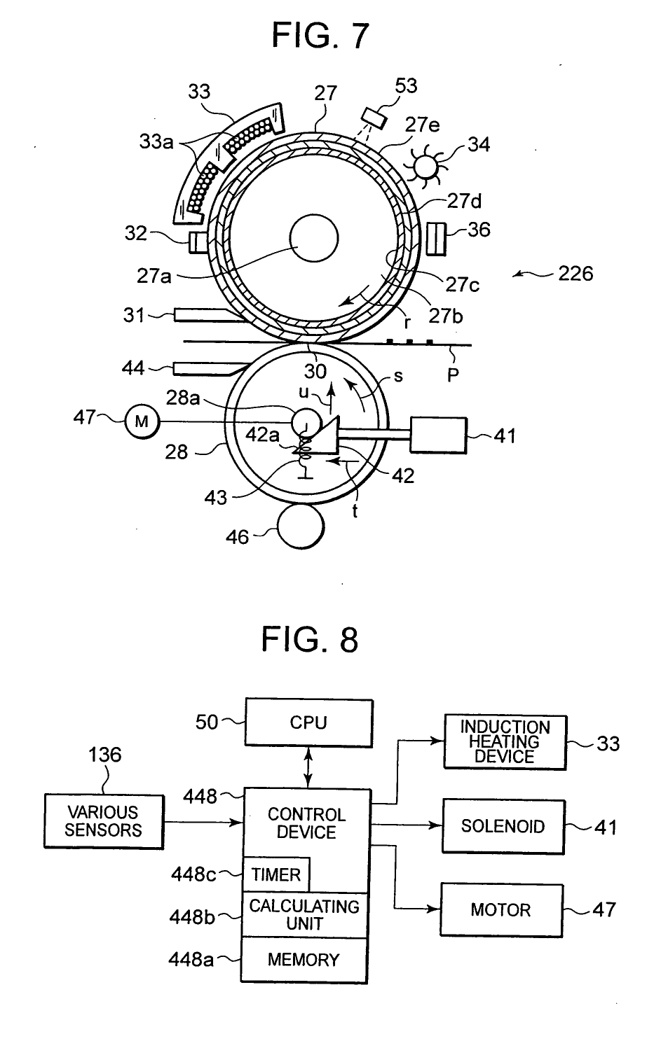

As shown in FIG. 6 showing the third embodiment, a fixing device 226 includes the motor 47 on the side of the shaft member 28a of the pressure roller 28, and the heat roller 27 is driven by the pressure roller 28 as in the second embodiment. A mark 52 for reading the number of rotations of the heat roller 27 is formed at one end of the releasing layer 27e on the outer periphery of the heat roller 27. As shown in FIG. 7, a photo coupler 53 for detecting the mark 52 is provided at a position in a range extending from the induction heating device 33 to the cleaning device 34 around the heat roller 27. The velocity of the movement of the mark 52, which corresponds to the detected result of the photo coupler 53 is supplied to the control device 48.

As in the case of the second embodiment, when the warming up is started, the pressing force of the pressure roller 28 with respect to the heat roller 27 is set to 5 kg. When the warming up is started and the motor 47 is driven, the heat roller 27 is driven and rotated by the driving rotation of the pressure roller 28. However, when the warming up is started, the heat roller 27 and the pressure roller 28 are in pressure contact with each other only at the both end portions 127b of the heat roller 27, and hence the heat roller 27 cannot be provided with the sufficient rotational force. Therefore, the rotation of the heat roller 27 is not stabilized, and the velocity of movement of the mark 52 detected by the photo coupler 53 varies.

Subsequently, when the heat roller 27 is heated, and the foam rubber layer 27b and the metal conductive layer 27c at the center portion 227b are brought into tight contact with each other, the driving rotation of the pressure roller 28 is transmitted to the entire length of the heat roller 27 in the longitudinal direction. Accordingly, the heat roller 27 is provided with the sufficient rotational force from the pressure roller 28, and hence the rotation of the heat roller 27 is stabilized. When the rotation of the heat roller 27 is stabilized and the velocity of movement of the mark 52 detected by the photo coupler 53 becomes constant, the warming up of the heat roller 27 is completed, and the fact that it is a ready state is displayed considering that the foam rubber layer 27b has achieved a predetermined expansion. The control device 48 turns the solenoid 41 ON, and the pressing force of the pressure roller 28 with respect to the heat roller 27 is set to 40 kg. Subsequently, the image forming process is carried out as in the second embodiment. After having terminated the entire image forming process, the power source is turned OFF and the pressing force of the pressure roller 28 with respect to the heat roller 27 is set back to 5 kg.

According to this embodiment, as in the second embodiment, the nip 30 is provided with the pressing force uniformly over the entire length of the heat roller 27 in the longitudinal direction at the time of fixation.

Consequently, a fixed image which is uniform and desirable is obtained over the entire length of the scanning direction.

Furthermore, according to this embodiment, the pressing force of the pressure roller 28 with respect to the heat roller 27 is set to a low value until the velocity of movement of the releasing layer 27e on the outer periphery of the heat roller 27 is stabilized, while the pressing force of the pressure roller 28 with respect to the heat roller 27 is increased only after the velocity of movement of the releasing layer 27e of the heat roller 27 is stabilized or when the image forming process is carried out after the velocity of movement of the releasing layer 27e of the heat roller 27 is stabilized. Therefore, even when the heat roller 27 and the pressure roller 28 are brought into pressure contact with each other only at the both end portions 127b of the heat roller 27 at a low temperature, the load applied to the both end portions 127b of the heat roller 27 is low. Consequently, damage of the both end portions 127b of the foam rubber layer 27b which is caused by concentration of the load to the both end portions 127b of the foam rubber layer 27b can be prevented, and hence the long lifetime of the heat roller 27 is achieved.

Subsequently, a fourth embodiment of the present invention will be described. In addition to the second embodiment described above, the fourth embodiment is configured in such a manner that detection of the drive/driven relation between the heat roller 27 and the pressure roller 28 is carried out using a predetermined warming up time (a time period required for the warming up), and other configurations are the same as those in the second embodiment. Therefore, in the fourth embodiment, the parts as those described in the second embodiment are represented by the same reference numerals and detailed description thereof are omitted.

In the fourth embodiment, as shown in FIG. 8, a reference warming up time is stored in a memory 448a, for example, in a control device 448. For example, when the room temperature is, for example, 25° C., a time period of 30 seconds from a moment when the power source is turned ON until the temperature of the heat roller 27 reaches 170° C. which is the warming up completion temperature is stored. Then, the memory 448a further stores, for example, 60 seconds, as a time period from the completion of the warming up until the foam rubber layer 27b reaches a predetermined expansion. A calculating unit 448b in the control device 48 converts the warming up time corresponding to the respective room temperature from the reference warming up time.

When the warming up is started, the pressing force of the pressure roller 28 with respect to the heat roller 27 is set to 5 kg. When the room temperature at the time of starting the warming up is, for example, 25° C., the warming up time stored in the memory is 30 seconds, and hence the control device 448 drives the motor 47 and supplies the drive current to the induction heating coil 33a for 30 seconds. A timer 448c counts 90 seconds in total, that is, 30 seconds from the starting of the warming up and 60 seconds until the foam rubber layer 27b has achieved a predetermined expansion. When counted, the control device 448 turns the solenoid 41 ON, and set the pressing force of the pressure roller 28 with respect to the heat roller 27 to 40 kg.

At this time, the heat roller 27 has reached 170° C., which is the warming up completion temperature, and hence the form rubber layer 27b and the metal conductive layer 27c of the center portion 227b are in tight contact with each other. Therefore, the load by the pressing force of the pressure roller 28 with respect to the heat roller 27 is dispersed over the entire length of the heat roller 27# in the longitudinal direction.

Subsequently, the image forming process is carried out in the same manner as the second embodiment. After having terminated the entire image forming process, the power source is turned OFF and the pressing force of the pressure roller 28 with respect to the heat roller 27 is reduced back to 5 kg.

When the room temperature when the warming up is started is not 25° C., the calculating unit 448b calculates the warming up time corresponding to the respective room temperatures from the reference warming up time. For example, when the warming up time of 60 seconds is calculated at a room temperature of 10° C., the power source is turned ON and the drive current is supplied to the induction heating coil 33a for 60 seconds. Then after 60 seconds are elapsed, the pressing force of the pressure roller 28 with respect to the heat roller 27 is set to 40 kg.

Although the reference warming up time is set and the warming up time corresponding to the respective room temperatures is calculated using the calculating unit 448b in this embodiment, it is not limited thereto. For example, it is also possible to store a time table in which the warming up time corresponding to the respective room temperatures are listed in the memory 448a, and when the warming up time corresponding to the room temperature found by referencing the time table has elapsed, turn the solenoid 41 ON.

According to this embodiment, as in the second embodiment, the nip 30 is provided with the pressing force uniformly over the entire length of the heat roller 27 in the longitudinal direction at the time of fixation. Consequently, a fixed image which is uniform and desirable is obtained over the entire length of the scanning direction.

Furthermore, in this embodiment, the warming up time is calculated and the pressing force of the pressure roller 28 with respect to the heat roller 27 is set to a low value during the warming up time, while when the warming up time is elapsed, or only when the image forming process is carried out after the warming up time is elapsed, the pressing force of the pressure roller 28 with respect to the heat roller 27 is increased. Therefore, the load applied to the both end portions 127b of the heat roller 27 at a low temperature can be reduced. Consequently, damage at the boundary at the both end portions 127b of the foam rubber layer 27b with respect to the shaft member 27a which is caused by concentration of the load to the both end portions 127b of the foam rubber layer 27b can be prevented, and hence the long lifetime of the heat roller 27 is achieved.

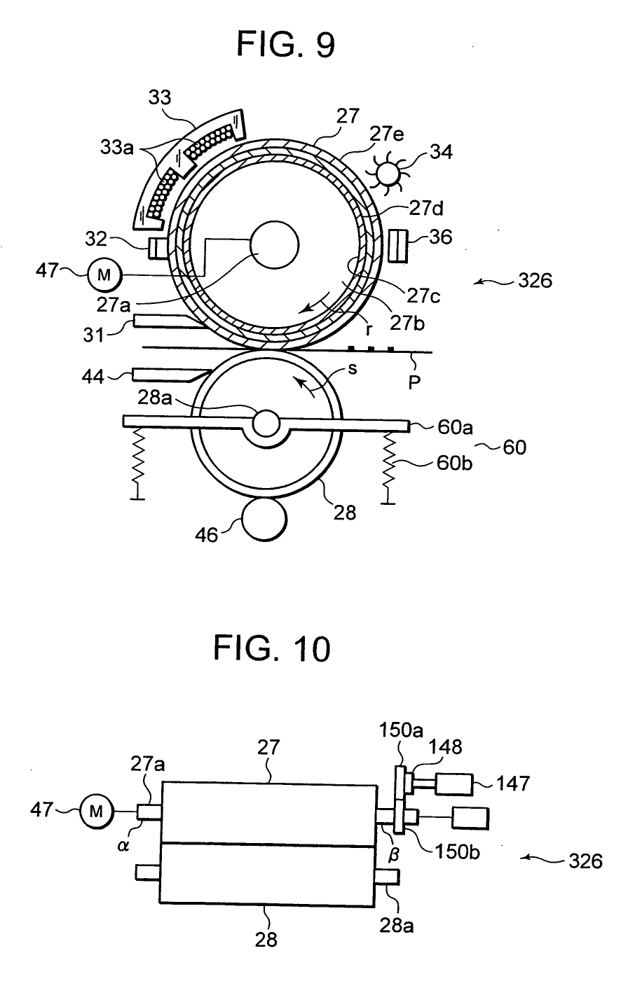

Subsequently, a fifth embodiment of the present invention will be described. In addition to the first embodiment described above, the fifth embodiment is configured in such a manner that the both ends of the heat roller 27 are driven as needed, and other configurations are the same as those in the first embodiment. Therefore, in the fifth embodiment, the parts as those described in the first embodiment are represented by the same reference numerals and detailed description thereof are omitted. In the fifth embodiment, as shown in FIG. 9 and FIG. 10, the pressure roller 28 of the fixing device 326 pushes up the shaft member 28a with a bearing member 60 to bring the same into pressure contact with the heat roller 27 at a pressing force of 40 kg. The bearing member 60 pushes a bearing bar 60a for supporting the shaft member 28a constantly toward the heat roller 27 by a spring 60b.

The motor 47 as a main drive mechanism is connected to one side a of the shaft member 27a of the heat roller 27. An auxiliary motor 147 as an auxiliary drive mechanism and the encoder 51 are connected to the other side β of the shaft member 27a. The auxiliary motor 147 supplies a drive force to the heat roller 27 only when necessary via a first gear 150a and a second gear 150b whose rotations are controlled by an electromagnetic clutch 148, which is turned ON and OFF by the control device 48. The number of rotations of the shaft member 27a detected by the encoder 51 is supplied to the control device 48.

When the warming up by turning the power source of the image forming apparatus 1 ON is started, the pressure roller 28 is pushed up by the bearing member 60 so that the pressing force of the pressure roller 28 with respect to the heat roller 27 becomes 40 kg. When the warming up is started, the control device 48 drives the motor 47 and supplies the drive current to the induction heating coil 33a. Accordingly, the pressure roller 28 is driven and rotated by the heat roller 27.

During this time, the encoder 51 detects the rotational velocity of the other side β of the shaft member 27a. A space is formed at the center portion 227b of the heat roller 27 until the warming up is completed, and the heat roller 27 and the pressure roller 28 is brought into pressure contact only at the both end portions 127b of the heat roller 27. Therefore, the load is concentrated to the boundary portion between the shaft member 27a and the foam rubber layer 27b at both end portions 127b of the heat roller 27 by the pressure from the pressure roller 28, which resists the rotation of the heat roller 27. Consequently, the rotation of the shaft member 27a is retarded on the β side, to which the motor 27 is not connected.

When the difference in rotational velocity between the one side α and the other side β of the shaft member 27a from the detected result of the encoder 51 is known, the control device 48 turns the electromagnetic clutch 148 ON to connect the drive of the auxiliary motor 147 to the first gear 150a. Furthermore, the rotation of the first gear 150a is transmitted to the shaft member 27a via the second gear 150b, and the β side of the shaft member 27a receives the auxiliary supply of the rotational drive force at the same velocity as the one side α.

Accordingly, the rotations of the both ends of the shaft member 27a are equalized, and when it is detected by the output from the encoder 51, the electromagnetic clutch 148 is turned OFF to stop the auxiliary drive on the β side of the shaft member 27a. Since the heating of the metal conductive layer 27c is proceeded during this time, the foam rubber layer 27b and the metal conductive layer 27c are brought into tight contact with each other at the center portion 227b of the heat roller 27. Therefore, the load from the pressure roller 27 is dispersed over the entire length of the heat roller 27, and hence the rotational retard of the shaft member 27a on the β side is cancelled. After the warming up is completed, the image forming process is carried out as in the first embodiment after having waited until the predetermined expansion of the foam rubber layer 27b is achieved, for example, about 60 seconds.

Although the rotational velocity of the shaft member 27a is detected and the auxiliary drive by the auxiliary motor 147 is carried out in this embodiment, the drive control by the auxiliary motor 147 is not limited thereto. For example, it is also possible to set in such a manner that the β side of the shaft member 27a is driven by the auxiliary motor 147 from the start of the warming up until the warming up time is elapsed.

According to this embodiment, as in the first embodiment, the nip 30 is provided with the pressing force uniformly over the entire length of the heat roller 27 in the longitudinal direction at the time of fixation. Consequently, a fixed image which is uniform and desirable is obtained over the entire length of the scanning direction.

Furthermore, in this embodiment, the rotational drive force is supplied to the β side of the shaft member 27a of the heat roller 27 by the auxiliary motor 147 until the delay of the rotational velocity of the shaft member 27a of the heat roller 27 that is caused by the load of the pressure roller 28 is cancelled. Therefore, damage of the foam rubber layer 27b at the both end portions 127b of the heat roller 27 can be prevented, and hence the long lifetime of the heat roller 27 is achieved.

The present invention is not limited to the above-described embodiments, and various modifications may be made within the range of the present invention. The shape of the resilient member layer is not limited, and the shape of the space between the resilient member layer and the induction heating member is not limited as long as it can absorb the thermal expansion of the resilient member layer. For example, the center portion of the resilient member layer may be formed like a sawtooth. The coefficient of resiliency of the resilient member layer is also arbitrary. Furthermore, the characteristics of the heating roller is not limited, and the warming up time, the temperature of the heat roller when the warming up is completed are not limited as well. A waiting period until the predetermined expansion of the resilient member layer is achieved after completion of the warming up is not limited as well.

As described in detail above, according to the present invention, the hardness of the heating roller at the time of fixation can be made substantially uniform over the entire length thereof in the longitudinal direction. Therefore, the uniform pressing force can be applied to the nip between the heating roller and the pressing member over the entire length thereof in the longitudinal direction, whereby a desirable fixed image can be obtained. In addition, according to the present invention, the load applied to the heating roller by the contact with the pressure roller is reduced until the hardness of the heating roller becomes substantially uniform over the entire length thereof in the longitudinal direction. Accordingly, the heating roller is prevented from becoming damaged in an early stage, and the long lifetime is achieved.

What is claimed is:

1. A fixing device for an image forming apparatus comprising:
a heating rotary member formed by covering a surface of a resilient member layer with a metal conductive layer;
an induction heating mechanism for generating an induction current in the metal conductive layer;
a pressure member which can come into contact with the heating rotary member for nipping and carrying a recording medium with the heating rotary member; and
a pressing mechanism which can vary a pressing force of the pressure member with respect to the heating rotary member in a plurality of steps or release the pressing force of the pressure member with respect to the heating rotary member.

2. The fixing device for an image forming apparatus according to claim 1, wherein the resilient member layer is smaller in outer diameter at a center portion than both end portions in the longitudinal direction and is bonded with the metal conductive layer at the both end portions.

3. The fixing device for an image forming apparatus according to claim 2, wherein the pressing force applied by the pressure mechanism is larger when the recording medium is nipped and carried than when the warming up of the heating rotary member is completed.

4. The fixing device for an image forming apparatus according to claim 2, wherein the pressing force applied by the pressure mechanism is larger when the recording medium is nipped and carried than when the heating rotary member is ready.

5. The fixing device for an image forming apparatus according to claim 2, wherein the pressure mechanism varies the pressing force according to variations in temperature of the heating rotary member.

6. The fixing device for an image forming apparatus according to claim 2, wherein the pressure member is connected to a drive mechanism and the heating rotary member is in contact with the pressure member and hence is rotated thereby, and the pressure mechanism varies the pressing force according to the velocity of the driven rotation of a shaft of the heating rotary member caused by the pressure member.

7. The fixing device for an image forming apparatus according to claim 2, wherein the pressure member is connected to the drive mechanism and the heating rotary member is in contact with the pressure member and hence is rotated thereby, and the pressure mechanism varies the pressing force according to the velocity of the driven rotation of an outer periphery of the heating rotary member caused by the pressure member.

8. The fixing device for an image forming apparatus according to claim 2, wherein the pressure mechanism varies the pressing force after a warming up time of the heating rotary member is ended.

9. A fixing device for an image forming apparatus comprising:
a heating rotary member formed by covering a surface of a resilient member layer with a metal conductive layer;
an induction heating mechanism for generating an induction current in the metal conductive layer;
a pressure member which can contact with the heating rotary member for nipping and carrying a recording medium with the heating rotary member;
a main drive mechanism for applying a drive force to one side of the heating rotary member in the longitudinal direction when the heating rotary member is rotated; and
an auxiliary drive mechanism for applying an auxiliary drive force to an opposite side of the heating rotary member in the longitudinal direction so as to be capable of releasing the auxiliary drive force while the drive force is applied to the heating rotary member by the main drive mechanism.

10. The fixing device for an image forming apparatus according to claim 9, wherein the resilient member layer is smaller in outer diameter at a center portion than both end portions in the longitudinal direction and is bonded with the metal conductive layer at the both end portions.

11. The fixing device for an image forming apparatus according to claim 10, wherein the auxiliary drive mechanism applies or releases the auxiliary drive force by the auxiliary drive mechanism according to the rotational velocity of an outer periphery of the opposite side in the longitudinal direction.

12. The fixing device for an image forming apparatus according to claim 11, wherein the auxiliary drive mechanism applies the auxiliary drive force during warming up time of the heating rotary member and releases the auxiliary drive force after the warming up time is ended.

13. A fixing method of an image forming apparatus that nips and carries a recording medium between a heating rotary member formed by covering a surface of a resilient member layer with a metal conductive layer and a pressure member which can come in pressure contact with the heating rotary member comprising the steps of;
heating the metal conductive layer by induction heating; and
varying a pressing force of the pressure member with respect to the heating rotary member in a plurality of stages or releasing the pressing force thereof.

14. The fixing method of an image forming apparatus according to claim 13, wherein the resilient member layer is smaller in outer diameter at a center portion than both end portions in the longitudinal direction and is bonded with the metal conductive layer at the both end portions.

15. The fixing method of an image forming apparatus according to claim 14, wherein the pressing force is varied so as to be larger when the recording medium is nipped and carried than when the warming up of the heating rotary member is completed.

16. The fixing method of an image forming apparatus according to claim 14, wherein the pressing force is varied so as to be larger when the recording medium is nipped and carried than when the heating rotary member is ready.

17. The fixing method of an image forming apparatus according to claim 14, wherein the pressing force is varied according to variations in temperature of the heating rotary member.

18. The fixing method of an image forming apparatus according to claim 14, wherein the pressing force is varied according to the velocity of the rotation of a shaft of the heating rotary member caused by the pressure member.

19. The fixing method of an image forming apparatus according to claim 14, wherein the pressing force is varied according to the velocity of the rotation of an outer periphery of the heating rotary member caused by the pressure member.

20. The fixing method of an image forming apparatus according to claim 14, wherein the pressing force is varied after the warming up time of the heating rotary member is ended.
